(19) United States
(12) Patent Application Publication
(10) Pub. No.: US 2007/0162634 A1
(43) Pub. Date: Jul. 12, 2007

(54) Communication apparatus and communication control method

(75) Inventor: Jun Okazaki, Yokohama-Shi (JP)

Correspondence Address: BANNER & WITCOFF, LTD.;ATTORNEYS FOR CLIENT NO. 000449, 001701, 1100 13th STREET, N.W., SUITE 1200, WASHINGTON, DC, 20005-4051, US

(73) Assignee: Kabushiki Kaisha Toshiba, Minato-ku (JP)

(21) Appl. No.: 11/593,127

(22) Filed: Nov. 6, 2006

(30) Foreign Application Priority Data
Nov. 8, 2005 (JP) 2005-323472

(51) Int. Cl. G06F 3/00

(52) U.S. Cl. 710/15

(57) ABSTRACT

A communication apparatus of an embodiment of the present invention is provided with a wired interface and a wireless interface for connecting devices, and includes a same device detecting unit configured to detect whether or not the same device is connected to the wired interface and the wireless interface, and a switching unit configured to, if the same device detecting unit detects that the same device is connected to the wired interface and the wireless interface, switch between using the wired interface and using the wireless interface for the device.

### CROSS REFERENCE TO RELATED APPLICATION

This application is based upon and claims the benefit of priority from the prior Japanese Patent Application No. 2005-323472, filed on Nov. 8, 2005, the entire contents of which are incorporated herein by reference.

### BACKGROUND OF THE INVENTION

1. Field of the Invention

The present invention relates to a communication apparatus and a communication control method, for example to a communication apparatus (USB enabled PC and the like) provided with a wired interface (USB 2.0 and the like) and a wireless interface (Wireless USB and the like) for connecting devices (USB enabled HDD and the like), and a communication control method of controlling the communication apparatus. HDD corresponds to the abbreviation for “Hard Disk Drive”, PC corresponds to the abbreviation for “Personal Computer”, and USB corresponds to the abbreviation for “Universal Serial Bus”.

2. Background Art

Standards with regard to short-range wireless transmission technologies (Personal Area Network (PAN)) such as Wireless USB and Wireless IEEE 1394 have been progressively developed. Also, there is a possibility that Wireless USB enabled devices will come on the market as products shortly.

Generally, when devices are to be connected via a wireless interface, an authentication is performed between the devices to be connected, for prevention of connecting to unintended devices and leaking of secrets of data. A proposed Wireless USB standard currently under discussion proposes an authentication scheme of performing the authentication by using a wired interface first, for a device attempting to participate in a wireless network, in order to simplify the authentication between the devices. This may require the Wireless USB enabled devices to include both of wired and wireless USB interfaces. Even if not so, the Wireless USB enabled devices are likely to include both of wired and wireless USB interfaces, from the viewpoint of handling wired USBs already on the market.

As described above, Wireless USB enabled devices and Wireless IEEE 1394 enabled devices are expected to include both of wired and wireless interfaces. Consequently, there is a possibility that one USB device (USB enabled HDD and the like) will be connected to both of wired and wireless USB interfaces of one USB host (USB enabled PC and the like). Specifically, for example, when the USB device and the USB host, which are connected via the wired USB interface, come close to each other in a connectable area for the wireless USB interface, there is a possibility that they will also be connected via the wireless USB interface. This may cause the USB host to misidentify one USB device as two USB devices, cause operations of these devices to stop, or cause inconsistency in the communication between these devices. However, the USB standard does not prescribe a particular way of handling a USB device which is connected to both of wired and wireless USB interfaces of a USB host.

Furthermore, between the devices capable of using both of wired and wireless USB interfaces, using the wired USB interface may be desired in one case, but using the wireless USB interface may be desired in another case, depending on a user's preference, a device characteristics or a transmission status.

For example, although the wireless is easy to connect, the transmission speed of the wireless may be reduced below that of the wired in a bad transmission status. Therefore, even a user usually using the wireless for the former reason may hope to use the wired in the latter case.

For example, although USB 2.0 standard and Wireless USB standard have the same maximum transmission speed at present, the wireless is expected to have the maximum transmission speed (on the order of 1 Gbps) higher than that of the wired in the future. In this case, a user emphasizing the transmission speed may hope to use the wireless in a suitable transmission status, and may hope to use the wired in a bad transmission status.

For example, using the wired may be desired for a battery-driven USB device having a small remaining amount of battery, since the wireless requires large power consumption and is incapable of receiving power supply from the USB host.

However at present, a mechanism of selectively using the wired USB interface and the wireless USB interface depending on the user's preference, the device characteristics or the transmission status, between the devices capable of using both of the wired and wireless USB interfaces, is not proposed.

Japanese Patent Laid-Open No. 2003-280778 (hereinafter referred to as “Document 1”) discloses an electronic device for detecting whether a connected interface is wired or wireless, and using the wired in preference to the wireless if the wired is connected, and using the wireless if the wired is not connected. However, Document 1 has neither description nor suggestion with regard to the case that the same device is connected to the wired interface and the wireless interface. Furthermore, Document 1 has neither description nor suggestion of neither a mechanism of selectively using the wired interface and the wireless interface depending on the device characteristics or the transmission status, nor a mechanism of requiring intention confirmation or switching operation of the user to switch between the wired interface and the wireless interface.

Japanese Patent Laid-Open No. 2002-197051 (hereinafter referred to as “Document 2”) discloses a computer apparatus and the like for allowing a user to specify an effective communication adapter (interface), and using the communication adapter specified as effective by the user among available communication adapters. However, Document 2 has neither description nor suggestion with regard to the case that the same device is connected to the wired interface and the wireless interface. Furthermore, Document 2 has neither description nor suggestion of neither a mechanism of selectively using the wired interface and the wireless interface depending on the device characteristics or the transmission status, nor a mechanism of requiring intention confirmation or switching operation of the user to switch between the wired interface and the wireless interface.

### SUMMARY OF THE INVENTION

An embodiment of the present invention relates to, for example, a communication apparatus provided with a wired interface and a wireless interface for connecting devices, including:

a same device detecting unit configured to detect whether or not the same device is connected to the wired interface and the wireless interface; and

a switching unit configured to, if the same device detecting unit detects that the same device is connected to the wired interface and the wireless interface, switch between using the wired interface and using the wireless interface for the device.

Another embodiment of the present invention relates to, for example, a communication apparatus, including:

a wired interface for connecting a device;

a wireless interface for connecting a device; and

a switching unit configured to, if the same device is connected to the wired interface and the wireless interface, switch between using the wired interface and using the wireless interface for the device.

Another embodiment of the present invention relates to, for example, a communication control method of controlling a communication apparatus provided with a wired interface and a wireless interface for connecting devices, including controlling the communication apparatus to perform:

detecting whether or not the same device is connected to the wired interface and the wireless interface; and

if it is detected that the same device is connected to the wired interface and the wireless interface, switching between using the wired interface and using the wireless interface for the device.

### BRIEF DESCRIPTION OF THE DRAWINGS

FIG. 1 is a block diagram for illustrating an embodiment of the present invention;

FIG. 2 is a flowchart for illustrating the embodiment of the present invention;

FIG. 3 shows a specific example of a setting screen displayed on a display of a PC;

FIG. 4 shows a variation of the setting screen displayed on the display of the PC;

FIG. 5 shows a specific example of a message display screen displayed on the display of the PC; and

FIG. 6 shows a variation of the message display screen displayed on the display of the PC.

### DESCRIPTION OF THE EMBODIMENTS

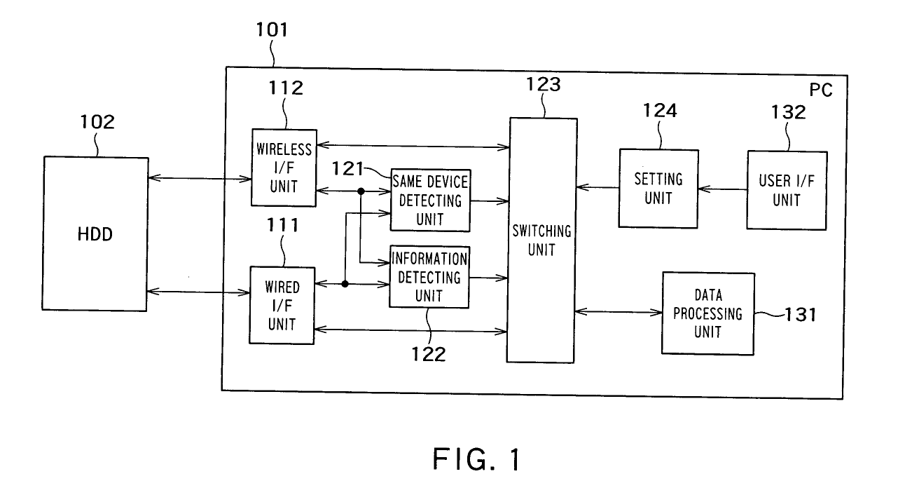

FIG. 1 is a block diagram for illustrating an embodiment of the present invention. FIG. 1 shows a PC 101 corresponding to a USB enabled PC (USB host), and a HDD 102 corresponding to a USB enabled HDD (USB device). Each of the PC 101 and the HDD 102 is provided with a wired USB interface and a wireless USB interface, and they will be connected to each other via the wired USB interface or/and the wireless USB interface.

The PC 101 in FIG. 1 is provided with a wired I/F (interface) unit 111, a wireless I/F (interface) unit 112, a same device detecting unit 121 corresponding to an example of same device detecting means, an information detecting unit 122 corresponding to an example of information detecting means, a switching unit 123 corresponding to an example of switching means, a setting unit 124 corresponding to an example of setting means, a data processing unit 131 and a user I/F (interface) unit 132.

The PC 101 is a device compliant with both of a wired USB standard (herein USB 2.0) and a wireless USB standard (herein Wireless USB), and is provided with both of the wired and wireless USB interfaces. The PC 101 includes an installed OS (Windows (registered trademark) XP and the like) supporting Plug & Play for USB enabled devices, and further includes an installed USB driver if necessary. Blocks of the same device detecting unit 121, the information detecting unit 122, the switching unit 123, the setting unit 124 and the like are herein realized by the OS, the USB driver, middleware or application software.

The HDD 102 is a device compliant with both of the wired USB standard (herein USB 2.0) and the wireless USB standard (herein Wireless USB), and is provided with both of the wired and wireless USB interfaces. The HDD 102 has information for uniquely identifying the HDD 102, that is, some identification information for identifying the HDD 102 separately from other devices. Specific examples include a MAC address, an ID for USB authentication, a GUID of IEEE standard and a device serial number. The HDD 102 may receive power supply through an AC adapter or the wired USB.

The wired I/F unit 111 is the block for providing the wired USB interface compliant with the wired USB standard (herein USB 2.0), and is configured with a wired USB connector and the like. The wired I/F unit 111 is connected to a body of the PC 101 via an internal bus (for example, a PCI bus) in the PC 101. Basic protocol processes are supposed to be processed by the data processing unit 131.

The wireless I/F unit 112 is the block for providing the wireless USB interface compliant with the wireless USB standard (herein Wireless USB), and is configured with a wireless USB antenna and the like. The wireless I/F unit 112 is connected to the body of the PC 101 via the internal bus (for example, the PCI bus) in the PC 101. Basic protocol processes are supposed to be processed by the data processing unit 131. An employed wireless scheme is herein UWB (Ultra Wide Band).

The same device detecting unit 121 is the block for detecting whether or not the same device is connected to the wired I/F unit 111 and the wireless I/F unit 112. The same device detecting unit 121 herein determines whether or not the same device is connected to the wired I/F unit 111 and the wireless I/F unit 112, by obtaining, from a device connected to the wired I/F unit 111, identification information of the device, obtaining, from a device connected to the wireless I/F unit 112, identification information of the device, and determining whether the former identification information and the latter identification information are same or not.

The information detecting unit 122 is the block, for detecting information (switching information) for switching between using the wired I/F unit 111 and using the wireless I/F unit 112 for the devices connected to the PC 101 (via the wired I/F unit 111 or/and the wireless I/F unit 112). Specific examples of the switching information include, information about transmission statuses or transmission characteristics of the wired I/F unit 111 or/and the wireless I/F unit 112 (transmission information), and information about statuses or characteristics of the devices connected to the PC 101 (device information).

The switching unit 123 is the block for, if the same device detecting unit 121 detects that the same device is connected to the wired I/F unit 111 and the wireless I/F unit 112, switching between using the wired I/F unit 111 and using the wireless I/F unit 112 for the device. The switching is executed in accordance with contents of setting set by the setting unit 124, or/and based on detected information detected by the information detecting unit 122.

The setting unit 124 is the block, for setting a setting (switching setting) for switching between using the wired I/F unit 111 and using the wireless I/F unit 112 for the devices to be connected to the PC 101 (via the wired I/F unit 111 or/and the wireless I/F unit 112). The setting is set in a setting destination, in other words, is registered in a registering destination, for example, is stored in a storage medium. The setting may be herein set for each device or each device type of the devices to be connected to the wired I/F unit 111 or/and the wireless I/F unit 112. The setting is edited with setting operations by a user through the user I/F unit 132.

The data processing unit 131 is the block for executing various kinds of data processing such as processes related to the control of the PC 101 and the like, and is configured with a CPU and the like. The data processing unit 131 executes the data processing of data which is transmitted between the PC 101 and the HDD 102.

The user I/F unit 132 is the block for providing various user I/Fs, and is configured with a keyboard, a mouse, a display and the like. The user I/F unit 132 provides a setting screen (a setting window, a setting dialog, a property setting screen and the like) for the setting operations concerning the switching setting.

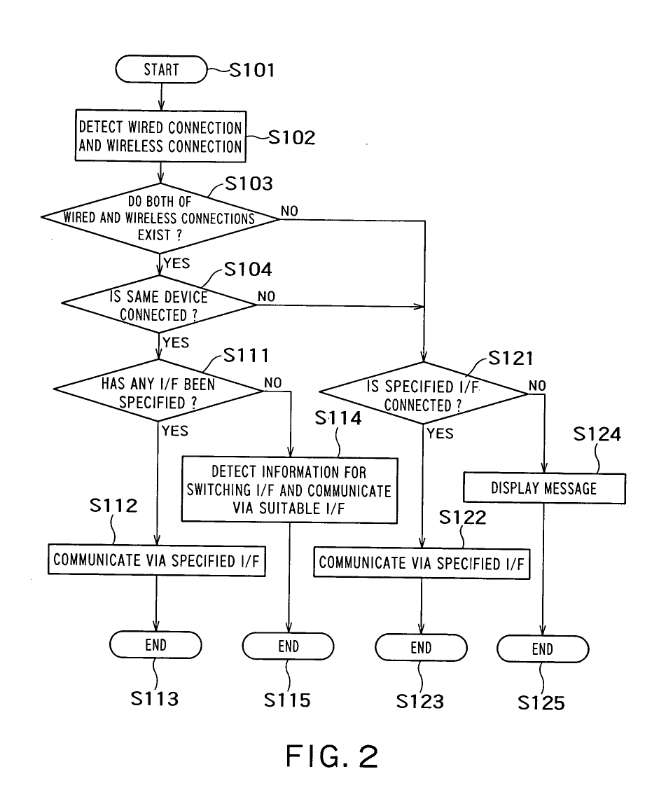

FIG. 2 is a flowchart for illustrating the embodiment of the present invention. FIG. 2 shows processing steps executed by the PC 101 in FIG. 1.

First at step S101, the PC 101 is turned on. Then the OS installed in the PC 101 is started. Then the wireless I/F unit 112 starts monitoring whether or not any device having the wireless USB interface exists in a connectable area. Meanwhile, the HDD 102 is assumed to have been received the power supply through the AC adapter, and it is assumed that the internal initialization of the HDD 102 has been completed. Also, the HDD 102 is assumed to have its wireless USB interface enabled, and it is assumed that an authentication process compliant with the wireless USB standard has been completed. Furthermore, the HDD 102 is supposed to be connected to the wired I/F unit 111 via a cable, and also to exist in the connectable area of the wireless I/F unit 112.

Next at step S102, the wired I/F unit 111 detects whether or not any device is connected to the wired I/F unit 111, and also the wireless I/F unit 112 detects whether or not any device is connected to the wireless I/F unit 112 (i.e. whether or not any device has participated in a network of the wireless I/F unit 112). If any device is connected to the wired I/F unit 111 via the cable, the wired I/F unit 111 detects that a device is connected to the wired I/F unit 111. If any device exists in the connectable area of the wireless I/F unit 112, the wireless I/F unit 112 detects that a device has participated in the network of the wireless I/F unit 112. When it is detected that a device is connected to the wired I/F unit 111 or the wireless I/F unit 112, the PC 101 executes various processes required for using the device, such as a process related to Plug & Play, a process of automatically incorporating a device driver and the like.

Subsequently, at step S103, the same device detecting unit 121 detects whether or not devices are connected to both of the wired I/F unit 111 and the wireless I/F unit 112. Then the process proceeds to step S104 if both connection are enabled, and the process proceeds to step S121 if only one of these connections is enabled.

Subsequently, at step S104, the same device detecting unit 121 detects whether or not the device connected to the wired I/F unit 111 and the device connected to the wireless I/F unit 112 are the same one device. The detection of whether or not they are the same device is executed using some information unique to the detected devices. Specific examples include authentication information for the wireless USB standard, key data for authentication, information provided by a vendor of the detected devices (for example, a serial number of each device or a product ID of each software) and the like. In addition, if each of the detected devices has a non-volatile storage medium, the PC 101 may write unique information in the storage medium to use this writing in the detection of whether or not they are the same device. Here it should be noted that the detection questions whether or not the “devices” are the same, but does not question whether or not the “types” of the devices are same. For example, if one device and the other device are different devices of the same type provided by the same vendor, the PC 101 addresses these devices individually. Then the process proceeds to step S111 if the same device is connected to the both I/Fs, and the process proceeds to step S121 if different devices are connected to the respective I/Fs.

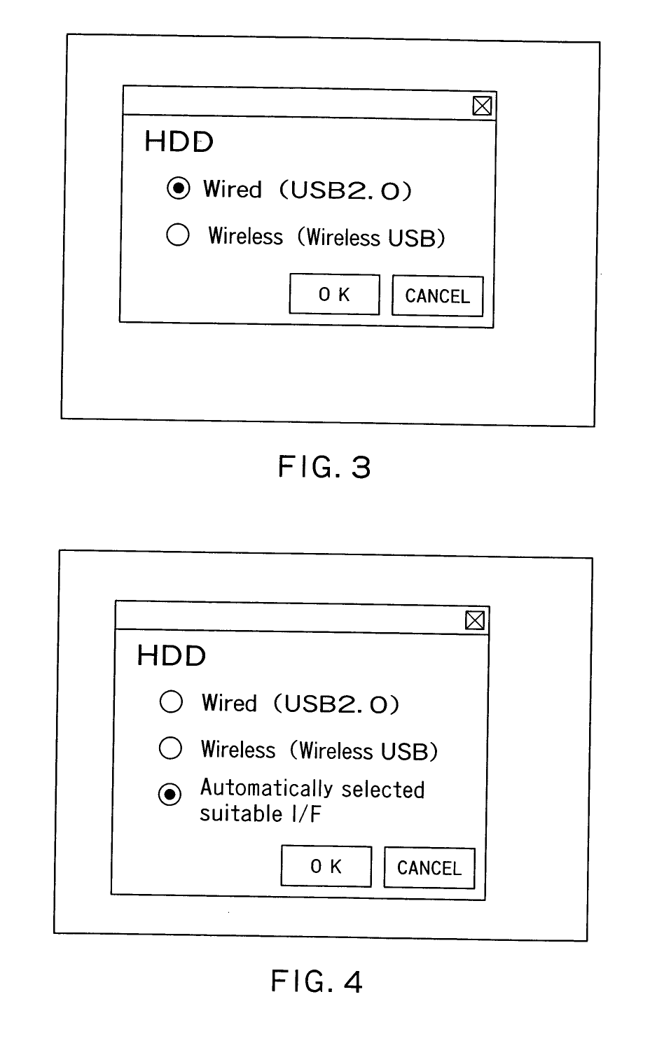

Then at step S111, the setting unit 124 determines whether or not the switching setting for switching between using the wired I/F unit 111 and using the wireless I/F unit 112 for the devices to be connected to the PC 101, has been set for the HDD 102 connected to the PC 101. FIG. 3 shows a specific example of the setting screen for the setting operations concerning the switching setting. On the setting screen in FIG. 3, the user can select one of “using the wired” and “using the wireless” for the HDD 102. If the user selects neither, “using automatically selected suitable one of the wired and the wireless” is selected by default. FIG. 4 shows a variation of the setting screen for the setting operations concerning the switching setting. On the setting screen in FIG. 4, the user can select one of “using the wired”, “using the wireless” and “using automatically selected suitable one of the wired and the wireless” for the HDD 102. In response to such setting operations on the setting screen, the setting unit 124 sets the switching setting. Although the setting screen in FIG. 3 is assumed to be applied to this embodiment, the setting screen in FIG. 4 is also applicable. If the switching setting has not been set for the HDD 102, a message prompting the user to the switching setting for the HDD 102 may be displayed (for example, “Select an I/F for the HDD.”). This is particularly useful when the HDD 102 is first used in the PC 101. Then the process proceeds to step S112 if the switching setting has been set, and the process proceeds to step S114 if the switching setting has not been set.

Subsequently, at step S112, the switching unit 123 switches between using the wired I/F unit 111 and using the wireless I/F unit 112 for the HDD 102 connected to the PC 101, in accordance with the contents of setting of the switching setting set by the setting unit 124. The contents of setting are provided from the setting unit 124 to the switching unit 123. If the contents of setting indicate “using the wired”, the switching unit 123 switches to using the wired only, and if the contents of setting indicate “using the wireless”, the switching unit 123 switches to using the wireless only. An I/F being unused may be slept or disabled, or may be enabled while being separately handled. The switching unit 123 may obtain the transmission information from the information detecting unit 122 at this step. Then, if the I/F to be switched to, has an unsuitable transmission status (the I/F has a bad transmission status, a low transmission band, a failure and the like), the switching unit 123 may display a message prompting the user to manually switching to the other I/F, or may automatically switch to the other I/F and inform the user of it (or without informing it).

Subsequently, step S113 is the state where the switching unit 123 has completed the switching, and the communication via the switched I/F has been already started. However, under this situation, the switching unit 123 may arbitrarily obtain the transmission information from the information detecting unit 122. Then, if the I/F being used has an unsuitable transmission status (the I/F has a bad transmission status, a low transmission band, a failure and the like), the switching unit 123 may display a message prompting the user to manually switching to the other I/F, or may automatically switch to the other I/F and inform the user of it (or without informing it).

Subsequently, at step S114, the switching unit 123 switches between using the wired I/F unit 111 and using the wireless I/F unit 112 for the HDD 102 connected to the PC 101, based on the detected information of the switching information detected by the information detecting unit 122. The detected information is provided from the information detecting unit 122 to the switching unit 123. In accordance with this information, the switching unit 123 automatically selects suitable one of the wired and the wireless, and switches the I/F to be used, to the suitable one of the wired I/F and the wireless I/F. Specific examples of criteria for determining the suitability will be described as follows.

For example, a transmission band of a wireless network may be used as the criteria for determination. The transmission band of the wireless network is significantly degraded due to many devices performing data transmission, and a great distance or an obstacle between the devices. On the other hand, there is a possibility that the advancement of the wireless technology will improve the transmission band of the wireless network. Therefore, in this case, information about a transmission status or a transmission characteristics of an I/F (or I/Fs), may be used as the switching information.

For example, the reliability of the data transmission may be used as the criteria for determination. For example, the wired is used to save data in the HDD 102, since high reliability is preferred for saving, and the wireless is used to load data from the HDD 102, since it is sufficient for loading with low reliability. Therefore, in this case, information about a status of data processing of data handled in an I/F (or I/Fs), may be used as the switching information.

For example, whether or not to handle data requiring security protection or copyright protection may be used as the criteria for determination. For example, the wired is used for handling said data, since high confidentiality is preferred for such data, and the wireless is used for handling other data, since it is sufficient for such data with low confidentiality. Therefore, in this case, information about data contents of data handled in an I/F (or I/Fs), may be used as the switching information.

For example, a scheme of the power supply for the connected devices may be used as the criteria for determination. For example, a device which is set to receive the power supply through the wired USB, may be required to use the wired USB, even if the contents of setting of the switching setting indicate “using the wireless”. For example, a battery-driven device having a small remaining amount of battery, may be required to charge the battery by using the wired USB. Therefore, in this case, information about statuses or characteristics of the connected devices, may be used as the switching information.

It should be noted that at step S114, the information detecting unit 122 executes the information detecting process before the switching process executed by the switching unit 123. In other words, the information detecting unit 122 detects the switching information for switching between using the wired I/F unit 111 and using the wireless I/F unit 112 for the devices connected to the PC 101, for the HDD 102 connected to the PC 101.

Subsequently, step S115 is the state where the switching unit 123 has completed the switching, and the communication via the switched I/F has been already started. However, under this situation, the switching unit 123 may arbitrarily obtain the transmission information from the information detecting unit 122. Then, if the I/F being used has an unsuitable transmission status (the I/F has a bad transmission status, a low transmission band, a failure and the like), the switching unit 123 may display a message prompting the user to manually switching to the other I/F, or may automatically switch to the other I/F and inform the user of it (or without informing it).

On the other hand, step S121 is the state where a device is connected to either the wired I/F unit 111 or the wireless I/F unit 112, or different devices are connected to the wired I/F unit 111 and the wireless I/F unit 112 respectively. For example, at step S121, a USB keyboard is connected to one of these I/Fs, or a USB keyboard and a USB mouse are connected to the respective I/Fs. At step S121, the setting unit 124 determines whether or not the I/F or each of the I/Fs connected to the device or each of the devices, is same as the I/F which is set in the switching setting for the device or each of the devices. Then the process proceeds to step S122 if the connected I/F(s) is same as the set I/F(s) for the device or all of the devices, and the process proceeds to step S124 if the connected I/F(s) is not same as the set I/F(s) for the device or any of the devices. It should be noted that the process may simply remain in a waiting state at step S121, instead of performing a determination process for realizing the branch into the step S122 and step S124.

Subsequently, at step S122, since the connected I/F is same as the set I/F for each device connected to the PC 101, the switching unit 123 switches between using the wired I/F unit 111 and using the wireless I/F unit 112 for each device, in accordance with the contents of setting of the switching setting for each device.

Subsequently, step S123 is the state where the switching unit 123 has completed the switching, and the communication via the switched I/F has been already started.

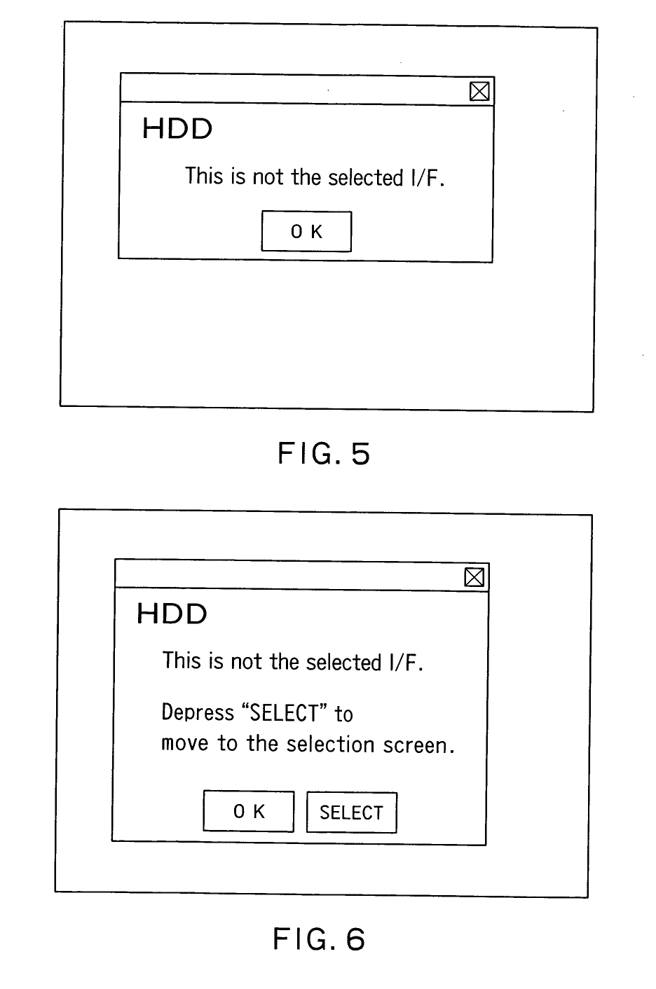

Subsequently, at step S124, since the connected I/F is not same as the set I/F for at least a device connected to the PC 101, the switching unit 123 displays a message indicating that the connected I/F and the set I/F are not same, for the device whose connected I/F and set I/F are not same. FIG. 5 shows a specific example of a message display screen indicating the message. The message display screen in FIG. 5 indicates that the connected I/F is not same as the set I/F for the HDD 102. FIG. 6 shows a variation of the message display screen indicating the message. The message display screen in FIG. 6 further permits the operation of moving to the setting screen for the switching setting. It should be noted that at step S124, the switching unit 123 may ignore the switching setting for each device connected to the PC 101, and display a message asking whether or not to use the currently connected I/F for each device connected to the PC 101.

Subsequently, step S125 is the state where the switching unit 123 has completed the switching, and the communication via the switched I/F has been already started. The changed I/F has been used for the device having the connected I/F or the set I/F changed at step S124. For the device selected to remain unchanged at step S124, the I/F connected at that time has been used.

In this way, the PC 101 can detect whether or not the same device is connected to the wired I/F unit 111 and the wireless I/F unit 112. Also, if the PC 101 detects that the same device is connected to the wired I/F unit 111 and the wireless I/F unit 112, the PC 101 can switch between using the wired I/F unit 111 and using the wireless I/F unit 112 for the device.

Thereby the PC 101 can appropriately deal with the situation where the same device is connected to the wired I/F unit 111 and the wireless I/F unit 112, such as by detecting whether or not the same device is connected to the wired I/F unit 111 and the wireless I/F unit 112, and if the PC 101 detects that the same device is connected to the wired I/F unit 111 and the wireless I/F unit 112, switching between using the wired I/F unit 111 and using the wireless I/F unit 112 for the device.

Furthermore, the PC 101 can set a setting (switching setting) for switching between using the wired I/F unit 111 and using the wireless I/F unit 112 for devices to be connected to the PC 101. Thereby the wired I/F unit 111 and the wireless I/F unit 112 may be selectively used depending on a user's preference.

Furthermore, the PC 101 can detect information (switching information) for switching between using the wired I/F unit 111 and using the wireless I/F unit 112 for devices connected to the PC 101. Thereby the wired I/F unit 111 and the wireless I/F unit 112 may be selectively used depending on transmission statuses or transmission characteristics of I/Fs, statuses or characteristics of connected devices, data contents or a status of data processing of handled data, and the like. Specific examples of criteria for determination for selectively using the I/Fs include, difference of transmission bands of the wired I/F and the wireless I/F, a failure in the wired I/F or the wireless I/F, remaining amount of the battery included in the connected device, importance of handled data and the like.

The PC 101 of this embodiment can execute both of the switching process in accordance with the switching setting and the switching process based on the switching information, while an embodiment may also be realized in which only one of the former and the latter switching processes can be executed. In the embodiment in which both of the switching process in accordance with the switching setting and the switching process based on the switching information can be executed, the switching process based on the switching information may be executed when the switching setting has not been set, as shown in FIG. 3, or the switching setting may set whether or not to execute the switching process based on the switching information, as shown in FIG. 4.

It should be noted that the PC and the HDD have been described as specific examples of the USB host and the USB device in this embodiment, while a variation with other USB host and other USB device may also be realized. Also, the wired USB and the wireless USB have been described as specific examples of the wired I/F and the wireless I/F in this embodiment, while a variation with Wired IEEE 1394 and Wireless IEEE 1394, a variation with the wired USB and Wireless IEEE 1394, and a variation with Wired IEEE 1394 and the wireless USB may also be realized. In other words, the wired I/F and the wireless I/F may be in the same standard or in different standards.

As described above, embodiments of the present invention make it possible, with regard to a communication apparatus provided with a wired interface and a wireless interface for connecting devices, to realize the communication apparatus capable of appropriately dealing with the situation where the same device is connected to the wired interface and the wireless interface.

What is claimed is:

1. A communication apparatus provided with a wired interface and a wireless interface for connecting devices, comprising:
same device detecting means for detecting whether or not the same device is connected to the wired interface and the wireless interface; and
switching means for, if the same device detecting means detects that the same device is connected to the wired interface and the wireless interface, switching between using the wired interface and using the wireless interface for the device.

2. The communication apparatus according to claim 1, further comprising:
setting means for setting a setting for switching between using the wired interface and using the wireless interface for the devices to be connected to the communication apparatus,
wherein the switching means is configured to, if the same device detecting means detects that the same device is connected to the wired interface and the wireless interface, switch between using the wired interface and using the wireless interface for the device, in accordance with contents of setting set by the setting means.

3. The communication apparatus according to claim 2, further comprising:
information detecting means for detecting information for switching between using the wired interface and using the wireless interface for the devices connected to the communication apparatus,
wherein the setting means is configured to be capable of setting the setting for, based on information to be detected by the information detecting means, switching between using the wired interface and using the wireless interface for the devices to be connected to the communication apparatus; and
the switching means is configured to, if the same device detecting means detects that the same device is connected to the wired interface and the wireless interface, switch between using the wired interface and using the wireless interface for the device, based on detected information detected by the information detecting means, in accordance with the contents of setting set by the setting means.

4. The communication apparatus according to claim 1, further comprising:
information detecting means for detecting information for switching between using the wired interface and using the wireless interface for the devices connected to the communication apparatus,
wherein the switching means is configured to, if the same device is connected to the wired interface and the wireless interface, switch between using the wired interface and using the wireless interface for the device, based on detected information detected by the information detecting means.

5. The communication apparatus according to claim 1, wherein the same device detecting means determines whether or not the same device is connected to the wired interface and the wireless interface, by obtaining, from a device connected to the wired interface, identification information of the device, obtaining, from a device connected to the wireless interface, identification information of the device, and determining whether the former identification information and the latter identification information are same or not.

6. The communication apparatus according to claim 1, wherein the same device detecting means detects whether or not devices are connected to both of the wired interface and the wireless interface, and if the same device detecting means detects that devices are connected to both of the wired interface and the wireless interface, the same device detecting means detects whether or not the device connected to the wired interface and the device connected to the wireless interface are the same device.

7. The communication apparatus according to claim 2, wherein the setting means is capable of setting the setting for each device or each device type of the devices to be connected to the communication apparatus.

8. The communication apparatus according to claim 2, wherein the setting means sets the setting in response to setting operations on a setting screen.

9. The communication apparatus according to claim 2, wherein if the setting has not been set for the device connected to the communication apparatus, the setting means displays a message prompting a user to the setting for the device.

10. The communication apparatus according to claim 2, wherein if an interface connected to a device is different from the interface set in the setting for the device, the setting means displays a message indicating that the interface connected to the device is different from the interface set in the setting for the device.

11. The communication apparatus according to claim 4, wherein the information detecting means detects, as the information, information about transmission statuses or transmission characteristics of the wired interface and/or the wireless interface.

12. The communication apparatus according to claim 4, wherein the information detecting means detects, as the information, information about statuses or characteristics of the devices connected to the communication apparatus.

13. The communication apparatus according to claim 4, wherein the information detecting means detects, as the information, information about data contents or a status of data processing of data handled in the wired interface and/or the wireless interface.

14. The communication apparatus according to claim 1, wherein the switching means displays a message prompting a user to manually switching to the other interface, depending on a transmission status of the interface being used.

15. The communication apparatus according to claim 1, wherein the switching means automatically switches to the other interface, depending on a transmission status of the interface being used.

16. A communication apparatus, comprising:
a wired interface for connecting a device;
a wireless interface for connecting a device; and
switching means for, if the same device is connected to the wired interface and the wireless interface, switching between using the wired interface and using the wireless interface for the device.

17. A communication control method of controlling a communication apparatus provided with a wired interface and a wireless interface for connecting devices, comprising controlling the communication apparatus to perform:
detecting whether or not the same device is connected to the wired interface and the wireless interface; and
if it is detected that the same device is connected to the wired interface and the wireless interface, switching between using the wired interface and using the wireless interface for the device.

18. The communication control method according to claim 17, comprising controlling the communication apparatus to perform:
setting a setting for switching between using the wired interface and using the wireless interface for the devices to be connected to the communication apparatus; and
in the switching, if it is detected that the same device is connected to the wired interface and the wireless interface, switching between using the wired interface and using the wireless interface for the device, in accordance with contents of setting in the setting.

19. The communication control method according to claim 18, comprising controlling the communication apparatus to perform:
detecting information for switching between using the wired interface and using the wireless interface for the devices connected to the communication apparatus;
in the setting, being capable of setting the setting for, based on information to be detected as the information, switching between using the wired interface and using the wireless interface for the devices to be connected to the communication apparatus; and
in the switching, if it is detected that the same device is connected to the wired interface and the wireless interface, switching between using the wired interface and using the wireless interface for the device, based on detected information detected as the information, in accordance with the contents of setting in the setting.

20. The communication control method according to claim 17, comprising controlling the communication apparatus to perform:
detecting information for switching between using the wired interface and using the wireless interface for the devices connected to the communication apparatus; and
in the switching, if the same device is connected to the wired interface and the wireless interface, switching between using the wired interface and using the wireless interface for the device, based on detected information detected as the information.
